(19) United States
(12) Patent Application Publication
(10) Pub. No.: US 2008/0286256 A1
(43) Pub. Date: Nov. 20, 2008

(54) Methods and Compositions for Killing Spores

(76) Inventors: Lars Henrik Oestergaard, Charlottenlund (DK); Bjoern Eggert Christensen, Bagsvaerd (DK); Steffen Danielsen, Copenhagen Oe (DK)

Correspondence Address: NOVOZYMES NORTH AMERICA, INC., 500 FIFTH AVENUE, SUITE 1600, NEW YORK, NY, 10110, US

(21) Appl. No.: 11/817,858

(22) PCT Filed: Mar. 7, 2006
(86) PCT No.: PCT/EP06/60511

§ 371 Date: Aug. 8, 2008

(30) Foreign Application Priority Data
Mar. 10, 2005 (DK) PA 2005 00356

(51) Int. Cl. A01N 63/00; A01P 1/00

(52) U.S. Cl. 424/94.4

(57) ABSTRACT

The invention provides a sporocidal composition comprising a laccase or a compound exhibiting laccase activity, a source of oxygen and a source of iodide ions. A method of killing or inactivating spores and a method of decontaminating a location, which has been exposed to spores, are also disclosed.

### TECHNICAL FIELD

The present invention relates to enzymatic methods for killing or inactivating microbial spores.

### BACKGROUND ART

Spores are known to form from aerobic Bacilli, anaerobic Clostridia, selected sarcinae and a few actinomycetes. Spores resemble certain plant seeds in that they do not carry out any metabolic reactions. In this regard they are especially suited to withstand severe environmental stress and are known to survive prolonged exposures to heat, drying, radiation and toxic chemicals. These properties make spores especially difficult to kill in environments, like living tissue or objects which come in contact with living tissue, which would be adversely effected by extreme conditions.

Fungi, viruses and vegetative cells of pathogenic bacteria are sterilized within minutes at 70 degrees Celsius; many spores are sterilized at 100 degrees Celsius. However, the spores of some saprophytes can survive boiling for hours. Heat is presently the most commonly used means to insure sterilization of spores.

A particularly difficult problem relates to microbiocidal treatment of bacterial spore-forming microorganisms of the Bacillus cereus group.

Microorganisms of the Bacillus cereus group include Bacillus cereus, Bacillus mycoides, Bacillus anthracis, and Bacillus thuringiensis. These microorganisms share many phenotypical properties, have a high level of chromosomal sequence similarity, and are known enterotoxin producers.

Although all spore-forming microorganisms are problematic for microbiocidal treatments because they form spores, Bacillus cereus is one of the most problematic because Bacillus cereus has been identified as possessing increased resistance to germicidal chemicals used to decontaminate environmental surfaces.

Bacillus cereus is a particularly well-established enterotoxin producer and food-borne pathogen. This organism is frequently diagnosed as a cause of gastrointestinal disorders and has been suggested to be the cause of several foodborne illness outbreaks. The organism is ubiquitous in nature, and as a consequence, is present in animal feed and fodder. Due to its rapid sporulating capacity, the organism easily survives in the environment and can survive intestinal passage in cows. The organism can contaminate raw milk via feces and soil, and Bacillus cereus can easily survive the pasteurization process.

The present invention provides an improved enzymatic method for killing or in-activating spores. The compositions and methods of the invention do not require use of an enhancing agent (mediator) to obtain a sporocidal effect. PCT application WO 03090542 A (NOVOZYMES A/S). 2003-11-06. mentions a number of enhancing agents, which are described as being mandatory in order to obtain a sporocidal effect in a laccase based system. It is easily recognized that the lack of requirement of an enhancing agent in the present invention makes the compositions and methods of the present invention both cheaper and simpler to apply compared to the prior art. Another advantage of the present invention is that decontamination of an environment exposed to spores will not result in spreading excessive amounts of chemicals, used as enhancing agents, in the environment.

### SUMMARY OF THE INVENTION

The present invention provides as a first aspect a sporocidal composition comprising a laccase or a compound exhibiting laccase activity, a source of oxygen and a source of iodide ions, wherein the composition does not include an enhancing agent. The sporocidal composition may also include surfactants, buffer systems and/or other formulation agents.

In a second aspect is provided a method of killing or inactivating spores, comprising contacting the spores with the sporocidal composition of the invention.

In a third aspect is provided a method of decontaminating a location, which has been exposed to spores, comprising contacting the spores with the sporocidal composition of the invention.

In a fourth aspect is provided a container comprising the composition of the invention, wherein the components of the composition are packaged in one or more compartments or layers.

In a fifth aspect is provided a ready-to-use sporocidal formulation comprising the composition of the invention.

In embodiments, the source of iodide may be one or more salts of iodide, such as sodium iodide or potassium iodide or mixtures thereof.

### DETAILED DESCRIPTION

### Laccases and Compounds Exhibiting Laccase Activity

Compounds exhibiting laccase activity may be any laccase enzyme comprised by the enzyme classification EC 1.10.3.2 as set out by the Nomenclature Committee of the International Union of Biochemistry and Molecular Biology (IUBMB), or any fragment derived therefrom exhibiting laccase activity, or a compound exhibiting a similar activity, such as a catechol oxidase (EC 1.10.3.1), an o-aminophenol oxidase (EC 1.10.3.4), or a bilirubin oxidase (EC 1.3.3.5).

Preferred laccase enzymes and/or compounds exhibiting laccase activity are enzymes of microbial origin. The enzymes may be derived from plants, bacteria or fungi (including filamentous fungi and yeasts).

Suitable examples from fungi include a laccase derivable from a strain of Aspergillus, Neurospora, e.g., N. crassa, Podospora, Botrytis, Collybia, Fomes, Lentinus, Pleurotus, Trametes, e.g., T. villosa and T. versicolor, Rhizoctonia, e.g., R. solani, Coprinus, e.g., C. cinereus, C. comatus, C. friesii, and C. plicatilis, Psathyrella, e.g., P. condelleana, Panaeolus, e.g., P. papilionaceus, Myceliophthora, e.g., M. thermophila, Schytalidium, e.g., S. thermophilum, Polyporus, e.g., P. pinsitus, Phlebia, e.g., P. radiata (WO 9201046 A (VALTION TEKNILLINEN). 1992-01-23.), or Coriolus, e.g., C. hirsutus (JP 2238885 (OJI PAPER). 1990-09-21.

Suitable examples from bacteria include a laccase derivable from a strain of Bacillus.

A laccase derived from Coprinus, Myceliophthora, Polyporus, Scytalidium or Rhizoctonia is preferred; in particular a laccase derived from Coprinus cinereus, Myceliophthora thermophila, Polyporus pinsitus, Scytalidium thermophilum or Rhizoctonia solani. Most preferably, the laccase is a Polyporus pinsitus laccase, or a variant derived thereof, such as a laccase having at least 80% identity to the Polyporus pinsitus laccase.

In another embodiment, the laccase has an oxidation potential of at least 0.54 V.

In yet another embodiment, the iodide binding site of the laccase is positively charged at the reaction conditions.

The laccase or the laccase related enzyme may furthermore be one which is producible by a method comprising cultivating a host cell transformed with a recombinant DNA vector which carries a DNA sequence encoding said laccase as well as DNA sequences encoding functions permitting the expression of the DNA sequence encoding the laccase, in a culture medium under conditions permitting the expression of the laccase enzyme, and recovering the laccase from the culture.

### Determination of Laccase Activity (LACU)

Laccase activity (particularly suitable for Polyporus laccases) may be determined from the oxidation of syringaldazin under aerobic conditions. The violet colour produced is photometered at 530 nm. The analytical conditions are 19 mM syringaldazin, 23 mM acetate buffer, pH 5.5, 30° C., 1 min. reaction time.

1 laccase unit (LACU) is the amount of enzyme that catalyses the conversion of 1.0 mmole syringaldazin per minute at these conditions.

### Determination of Laccase Activity (LAMU)

Laccase activity may be determined from the oxidation of syringaldazin under aerobic conditions. The violet colour produced is measured at 530 nm. The analytical conditions are 19 mM syringaldazin, 23 mM Tris/maleate buffer, pH 7.5, 30° C., 1 min. reaction time.

1 laccase unit (LAMU) is the amount of enzyme that catalyses the conversion of 1.0 mmole syringaldazin per minute at these conditions.

### Source of Oxygen

The source of oxygen required by the laccase or the compound exhibiting laccase activity may be oxygen from the atmosphere or an oxygen precursor for in situ production of oxygen. Oxygen from the atmosphere will usually be present in sufficient quantity. If more O₂ is needed, additional oxygen may be added, e.g. as pressurized atmospheric air or as pure pressurized O₂.

### Source of Iodide Ions

According to the invention the source of iodide ions needed for the reaction with the laccase may be achieved in many different ways, such as by adding one or more salts of iodide. In a preferred embodiment the salt of iodide is sodium iodide or potassium iodide, or mixtures thereof.

The concentration of the source of iodide ions will typically correspond to a concentration of iodide ions of from 0.01 mM to 1000 mM, preferably from 0.05 mM to 500 mM, more preferably from 0.1 mM to 100 mM, and most preferably 1 mM to 50 mM.

### Spores

The spores which are contacted with a laccase or a compound exhibiting laccase activity, a source of oxygen and a source of iodide ions in the method of the invention comprise all kinds of spores.

In an embodiment the spores are endospores, such as all Clostridium sp. spores, Brevibacillus sp. spores and Bacillus sp. spores, e.g. spores from Bacillus anthracis, Bacillus cereus, Bacillus mycoides, Bacillus thuringiensis, Bacillus subtilis, Bacillus putida, and Bacillus pumila.

In another embodiment the spores are exospores, such as Actinomycetales spores, e.g. spores from Actinomyces sp., Streptomyces sp., Thermoactinomyces sp., Saccharomonospora sp., and Saccharopylospora sp.

In another embodiment the spores are bacterial spores. Examples of bacterial spores include, but are not limited to, all Clostridium sp. spores and Bacillus sp. spores as mentioned above.

In yet another embodiment the spores are fungal spores. Examples of fungal spores include (in addition to those mentioned above), but are not limited to, conidiospores, such as spores from Aspergillus sp., and Penicillium sp.

### Surfactants

The surfactants suitable for being incorporated in the sporocidal composition may be non-ionic (including semi-polar), anionic, cationic and/or zwitterionic; or combinations thereof. The surfactants are preferably anionic or non-ionic. The surfactants are typically present in the sporocidal composition at a concentration of from 0.01% to 10% by weight.

When included therein, the sporocidal composition will usually contain from about 0.01% to about 10%, preferably about 0.05% to about 5%, and more preferably about 0.1% to about 1% by weight of an anionic surfactant, such as linear alkylbenzene-sulfonate, alpha-olefinsulfonate, alkyl sulfate (fatty alcohol sulfate), alcohol ethoxysulfate, secondary alkanesulfonate, alpha-sulfo fatty acid methyl ester, alkyl- or alkenylsuccinic acid or soap.

When included therein the sporocidal composition will usually contain from about 0.01% to about 10%, preferably about 0.05% to about 5%, and more preferably about 0.1% to about 1% by weight of a non-ionic surfactant, such as alcohol ethoxylate, nonylphenol ethoxylate, alkylpolyglycoside, alkyldimethylamineoxide, ethoxylated fatty acid monoethanolamide, fatty acid monoethanolamide, polyhydroxy alkyl fatty acid amide, or N-acyl N-alkyl derivatives of glucosamine (“glucamides”).

### Compositions

The present invention provides a composition comprising a laccase or a compound exhibiting laccase activity, a source of oxygen and a source of iodide ions; but not an enhancing agent.

The laccase or the compound exhibiting laccase activity and the source of iodide ions may be formulated as a liquid (e.g. aqueous), a solid, a gel, a paste or a dry product formulation. The dry product formulation may subsequently be re-hydrated to form an active liquid or semi-liquid formulation usable in the method of the invention.

When the laccase or the compound exhibiting laccase activity, the source of iodide ions and the enhancing agent are formulated as a dry formulation, the components may be mixed, arranged in discrete layers or packaged separately.

When formulated as a solid, all components may be mixed together, e.g., as a powder, a granulate or a gelled product.

When other than dry form compositions are used and even in that case, it is preferred to use a two-part formulation system having the enzyme(s) separate from the rest of the composition.

The composition of the invention may further comprise auxiliary agents such as wetting agents, thickening agents, buffer(s) for pH control, stabilisers, perfume, colourants, fillers and the like.

Useful wetting agents are surfactants, i.e. non-ionic, anionic, amphoteric or zwitterionic surfactants. Surfactants are further described above.

The composition of the invention may be a concentrated product or a ready-to-use product. In use, the concentrated product is typically diluted with water to provide a medium having an effective sporocidal activity, applied to the object to be cleaned or disinfected, and allowed to react with the spores present.

The pH of an aqueous solution of the composition is in the range of from pH 2 to 11, preferably in the range of from pH 3 to 10, more preferably in the range of from pH 3 to 9, most preferably in the range of from pH 3 to 7, and in particular in the range of from pH 3 to 6.

### Methods and Uses

The present invention provides an enzymatic method for killing or inactivating spores, comprising contacting the spores with a laccase or a compound exhibiting laccase activity, a source of oxygen and a source of iodide ions, but without the need for contacting the spores with an enhancing agent.

In the context of the present invention the term “killing or inactivating spores” is intended to mean that at least 90%, preferably at least 99%, of the spores are not capable of transforming (germinating) into vegetative cells. Preferably 99.9% (more preferably 99.99% and most preferably 99.999%) of the spores are not capable of transforming into vegetative cells.

The spores may be contacted by the composition of the invention at a temperature between 0 and 90 degrees Celsius, preferably between 5 and 80 degrees Celsius, more preferably between 10 and 70 degrees Celsius, even more preferably between 15 and 60 degrees Celsius, most preferably between 18 and 50 degrees Celsius, and in particular between 20 and 40 degrees Celsius.

The composition of the invention is suitable for killing or inactivating spores in a variety of environments. The composition of the invention may desirably be used in any environment to reduce spore contamination, such as the health-care industry (e.g. animal hospitals, human hospitals, animal clinics, human clinics, nursing homes, day-care facilities for children or senior citizens, etc.), the food industry (e.g. restaurants, food-processing plants, food-storage plants, grocery stores, etc.), the hospitality industry (e.g. hotels, motels, resorts, cruise ships, etc.), the education industry (e.g. schools and universities), etc.

The composition of the invention may desirably be used in any environment to reduce spore contamination, such as general-premise surfaces (e.g. floors, walls, ceilings, exterior of furniture, etc.), specific-equipment surfaces (e.g. hard surfaces, manufacturing equipment, processing equipment, etc.), textiles (e.g. cottons, wools, silks, synthetic fabrics such as polyesters, polyolefins, and acrylics, fiber blends such as cottonpolyester, etc.), wood and cellulose-based systems (e.g. paper), soil, animal carcasses (e.g. hide, meat, hair, feathers, etc.), foodstuffs (e.g. fruits, vegetables, nuts, meats, etc.), and water.

The composition of the invention may be used to reduce spore contamination of drinking water. This is preferably carried out by contacting the drinking water with an immobilized laccase. Several methods for immobilizing enzymes are known in the art.

In one embodiment, the method of the invention is directed to sporocidal treatment of textiles. Spores of the Bacillus cereus group have been identified as the predominant postlaundering contaminant of textiles. Thus, the treatment of textiles with a composition of the invention is particularly useful for sporocidal activity against the contaminants of textiles.

Examples of textiles that can be treated with the composition of the invention include, but are not limited to, personal items (e.g. shirts, pants, stockings, undergarments, etc.), institutional items (e.g. towels, lab coats, gowns, aprons, etc.), hospitality items (e.g. towels, napkins, tablecloths, etc.).

A sporocidal treatment of textiles with a composition of the invention may include contacting a textile with a composition of the invention. This contacting can occur prior to laundering the textile. Alternatively, this contacting can occur during laundering of the textile to provide sporocidal activity and optionally provide cleansing activity to remove or reduce soils, stains, etc. from the textile.

The spores which are contacted by the composition of the invention may be situated on any surface including, but not limited to, a surface of a process equipment used in e.g. a dairy, a chemical or pharmaceutical process plant, a piece of laboratory equipment, a water sanitation system, an oil processing plant, a paper pulp processing plant, a water treatment plant, or a cooling tower. The composition of the invention should be used in an amount, which is effective for killing or inactivating the spores on the surface in question.

The spores may be contacted with the composition of the invention by submerging the spores in an aqueous formulation of the composition (e.g. a laundering process), by spraying the composition onto the spores, by applying the composition to the spores by means of a cloth, or by any other method recognized by the skilled person. Any method of applying the composition of the invention to the spores, which results in killing or inactivating the spores, is an acceptable method of application.

The method of the invention is also useful for decontamination of locations which have been exposed to spores (e.g. pathogenic spores), such as biological warfare agents, e.g. spores of Bacillus anthrasis capable of causing anthrax. Such locations include, but are not limited to, clothings (such as army clothings), inner and outer parts of vehicles, inner and outer parts of buildings, any kind of army facility, and any kind of environment mentioned above.

The present invention is further described by the following examples which should not be construed as limiting the scope of the invention.

### EXAMPLES

Chemicals used as buffers and substrates were commercial products of at least reagent grade.

### Example 1

### Production of Spores

A Tryptose Blod Agar Base (TBAB) plate was streaked from a fresh culture of Bacillus thuringiensis (American Type Culture Collection 10801 University Blvd., Manassas, Va. 20110-2209 United States of America ATCC10792 ). The streaked plate was incubated overnight at 30 degrees Celsius.

A loopfull of pure B. thuringiensis cells from the TBAB plate was suspended in 2 ml of sterile water. 2×SG plates were each inoculated with 100 microliter of the cell suspension. The composition of 2×SG was as follows: 16 g/L Difco Bacto Nutrient Broth, 0.5 g/L MgSO₄×7H₂O, 2.0 g/L KCl, 1.0 g/L glucose, 1.0 mL/L of 1 M Ca(NO₃), 1.0 mL/L of 0.1 M MnSO₄, 0.1 mL/L of 0.01M FeSO₄, and 1% Difco Bacto Agar.

Plates were incubated for 48-72 hrs. at 30 degrees Celsius. Sporulation was checked with phase-contrast microscopy. Spores are phase-bright.

When sporulation efficiency was close to 100%, the cell lawn was harvested with water and the cells were suspended by intensive vortexing. Cells were collected by centrifugation for 5-10 minutes at 6,000 G at 4 degrees Celsius, and washed 3 times with ice-cold water. The pellet contained vegetative cells and spores.

A step-density gradient was applied for separation of the spores from the vegetative cells. A centrifuge tube containing 30 mL 43% Urographin® was prepared for each washed pellet. 3 mL of cell/spore mixture in Urographin was prepared so that the final Urographin concentration was 20%. This 20% Urographin mixture was gently loaded onto the top layer of the centrifuge tubes containing 43% Urographin.

The centrifuge tubes were centrifuged at 10,000 G at room temperature for 30 minutes. The supernatant was gently removed. The pure spore pellet was suspended in 1 ml ice-cold water and transferred to a microfuge tube. Centrifugation was continued at maximum speed for 1-2 min at 4 degrees Celsius, and the pellet was washed in ice-cold water 2 more times.

The purity and number of spores/ml was checked by phase contrast microscopy and a haemocytometer.

The spores were suspended to a density of approx. 1×10⁹ spores/mL in 0.01% Tween 80 and subjected to sonication in a Sonicator Bath (Branson 2200) for 30 minutes at room temperature. The sonicated spore suspension was gently filtered through a 5.0 μm syringe filter (very low pressure applied).

The spores were stored, suspended in water, at +4 degrees Celsius.

In order to estimate the viability, a sample of the spores was counted in a haemocytometer, a dilution series was made, and aliquots from this was plated on TBAB. The plates were incubated overnight at 30 degrees Celsius, the emerging colonies were counted, and the viability calculated. Viability of the spores was approx. 100%.

### Example 2

### Killing of Spores

The following reagents were prepared:

Bacillus thuringiensis spores were re-suspended in H₂O to a density of 2×10⁷ spores per ml;

Sodium acetate buffer 100 mM, pH 3.8;

Sodium acetate buffer, 100 mM, pH 5.0;

Sodium acetate buffer, 100 mM, pH 6.0;

Polyporus pinsitus laccase (as disclosed in WO 9600290 A (NOVO NORDISK A/S). 1996-01-04., FIG. 1, SEQ ID NO: 1; and available from Novozymes A/S) was diluted to approx. 25 mg/ml in H₂O;

200 mM Potassium iodide (KI) solution in water;

20 mM Methylsyringate (methyl 3,5-dimethoxy-4-hydroxybenzoate, Sigma S40,944-8) solution in Ethanol;

3 mM MTT (3-(4,5-Dimethylthiazol-yl)-2,5-diphenyltetrazolium bromide, Sigma M2128) solution in water;

TBB growth medium:

10 g/l Tryptose,

3 g/l Beef Extract,

5 g/l NaCl,

water ad 1000 ml

final pH 7.2+/−0.2.

50 microliter of spore suspension was pipetted into the wells in row A of a microtiter plate. The other reagents were added as indicated in table 1 below. The reaction was initiated by the addition of laccase solution.

TABLE 1
Microtiter plate layout

| | Acetate | | | Methyl- | | |
|---|---|---|---|---|---|---|
| | buffer | H₂O | KI | syringate | Spores | Laccase |
| Wells | (μL) | (μL) | (μL) | (μL) | (μL) | (μL) |
| A1-A2 | 60 | 90 | 0 | 0 | 50 | 0 |
| A3-A4 | 60 | 60 | 10 | 10 | 50 | 10 |
| A5-A6 | 60 | 69 | 10 | 1 | 50 | 10 |
| A7-A8 | 60 | 69 | 10 | 1 | 50 | 10 |
| | | | | (10 times) | | |
| | | | | diluted) | | |
| A9-A10 | 60 | 70 | 10 | 0 | 50 | 10 |
| A11-A12 | 0 | 150 | 0 | 0 | 50 | 0 |

A microtiter plate was made with each of the buffer values thus ending up with three plates, each with spores treated with laccase, iodide and methylsyringate (final concentrations of methylsyringate were 1.0 mM, 0.1 mM, 0.01 mM and 0 mM).

The microtiter plates were incubated at room temperature (24 degrees Celsius) for one hour. 50 microliter of 1% sodiumhydrogencarbonate was then added to wells A1-A10 and 50 microliter of sterile water was added to wells A11-12. 180 microliter TBB growth medium was added to all wells in rows B to H of the microtiter plates.

Serial 10 fold dilutions were made by pipetting 20 microliter from row A to row B, and then from row B to row C, and then from row C to row D, and so on until row H.

The microtiter plates were incubated at 30 degrees Celsius for 20-24 hours to allow spores to germinate and grow. Growth was evaluated by a microplate reader and visually by “developing the growth” by addition of 5 microliter 3 mM MTT to each well. Formation of purple formazans reveals bacterial growth and thus the degree of spore inactivation.

TABLE 2
Growth at pH 3.8

| | 1 | 2 | 3 | 4 | 5 | 6 | 7 | 8 | 9 | 10 | 11 | 12 |
|---|---|---|---|---|---|---|---|---|---|---|---|---|
| A | | | | | | | | | | | | |
| B | + | + | − | − | − | − | − | − | − | − | + | + |
| C | + | + | − | − | − | − | − | − | + | + | + | + |
| D | + | + | − | − | − | − | − | − | + | + | + | + |
| E | + | + | − | − | − | − | − | − | − | − | + | + |
| F | + | − | − | − | − | − | − | − | − | − | + | + |
| G | − | − | − | − | − | − | − | − | − | − | − | + |
| H | − | − | − | − | − | − | − | − | − | − | − | − |

TABLE 3
Growth at pH 5.0

| | 1 | 2 | 3 | 4 | 5 | 6 | 7 | 8 | 9 | 10 | 11 | 12 |
|---|---|---|---|---|---|---|---|---|---|---|---|---|
| A | | | | | | | | | | | | |
| B | + | + | − | − | − | − | − | − | + | + | + | + |
| C | + | + | − | − | − | − | − | + | + | + | + | + |
| D | + | + | − | − | − | − | + | − | + | + | + | + |
| E | + | + | − | − | − | − | − | − | + | − | + | + |
| F | + | + | − | − | − | − | − | − | − | − | + | + |
| G | + | − | − | − | − | − | − | − | − | − | − | − |
| H | − | − | − | − | − | − | − | − | − | − | − | − |

TABLE 4
Growth at pH 6.0

| | 1 | 2 | 3 | 4 | 5 | 6 | 7 | 8 | 9 | 10 | 11 | 12 |
|---|---|---|---|---|---|---|---|---|---|---|---|---|
| A | | | | | | | | | | | | |
| B | + | + | + | + | + | + | + | + | + | + | + | + |
| C | + | + | + | + | + | + | + | + | + | + | + | + |
| D | + | + | − | − | − | − | + | + | + | + | + | + |
| E | + | + | − | − | − | − | − | + | + | + | + | + |
| F | + | + | − | − | − | − | − | − | − | + | + | + |
| G | − | − | − | − | − | − | − | − | + | − | + | + |
| H | − | − | − | − | − | − | − | − | − | − | − | − |

The results in Tables 2, 3 and 4 show that Bacillus thuringiensis spores were in-activated by the laccase—both with and without addition of methylsyringate (enhancing agent).

At pH 3.8 a kill of 3 log units was obtained; at pH 5.0 a kill of approx. 2 log units was obtained; and at pH 6.0 a kill of approx. 1 log unit was obtained.

1. A sporocidal composition comprising a laccase or a compound exhibiting laccase activity, a source of oxygen and a source of iodide ions, wherein the composition does not include an enhancing agent.

2. The composition of claim 1, wherein the source of iodide ions is one or more salts of iodide.

3. The composition of claim 1, which further comprises a surfactant.

4. An enzymatic method of killing or inactivating spores, comprising contacting the spores with a laccase or a compound exhibiting laccase activity, a source of oxygen and a source of iodide ions, wherein the spores are not contacted with an enhancing agent.

5. The method of claim 4, wherein the source of iodide ions is one or more salts of iodide.

6. The method of claim 4, which further comprises contacting the spores with a surfactant.

7. The method of any of claim 4, wherein the spores are located on a surface.

8. The method of claim 7, wherein the surface is a textile surface.

9. The method of claim 7, wherein the surface is a surface of laboratory or process equipment.

10. A method of decontaminating a location, which has been exposed to spores, comprising contacting the spores with a laccase or a compound exhibiting laccase activity, a source of oxygen and a source of iodide ions, wherein the composition does not include an enhancing agent.

11. The method of claim 10, wherein the source of iodide ions is one or more sats of iodide.

12. The method of claim 10, which further comprises contacting the spores with a surfactant.

13. A container comprising the composition of claim 1, wherein the components of the composition are packaged in one or more compartments or layers.

14. A ready-to-use sporocidal formulation comprising the composition of claim 1.

15. Use of a laccase for killing of spores without using an enhancing agent.
